(19) United States
(12) Patent Application Publication
(10) Pub. No.: US 2022/0107972 A1
(43) Pub. Date: Apr. 7, 2022

(54) DOCUMENT SEARCH APPARATUS, METHOD AND LEARNING APPARATUS

(71) Applicant: KABUSHIKI KAISHA TOSHIBA, Tokyo (JP)

(72) Inventor: Kosei FUME, Kawasaki Kanagawa (JP)

(73) Assignee: KABUSHIKI KAISHA TOSHIBA, Tokyo (JP)

(21) Appl. No.: 17/462,144

(22) Filed: Aug. 31, 2021

(30) Foreign Application Priority Data
Oct. 7, 2020 (JP) 2020-169641

(51) Int. Cl. G06F 16/335; G06F 16/34; G06F 16/338

(52) U.S. Cl. CPC G06F 16/337; G06F 16/338; G06F 16/345

(57) ABSTRACT

According to one embodiment, a document search apparatus includes a processor. The processor searches, from a plurality of documents, one or more related documents which relate to a query. The processor extracts one or more topics of the one or more related documents. The processor determines a display order of the one or more related documents by using a trained model which generates the display order and summaries of documents. The processor generates summaries of the one or more related documents for each of the one or more topics, by using a determination result of the display order and the trained model.

### CROSS-REFERENCE TO RELATED APPLICATIONS

This application is based upon and claims the benefit of priority from Japanese Patent Application No. 2020-169641, filed Oct. 7, 2020, the entire contents of which are incorporated herein by reference.

### FIELD

Embodiments described herein relate generally to a document search apparatus, method and a learning apparatus.

### BACKGROUND

With the popularization of electronic data-based documents, electronic data of, for example, written questions in the Diet, and questions and answers in local assembly conference minutes, have been accumulated. In Web sites which provide such electronic data, a search function is provided for searching a target document by using, as a query, a keyword, a conference name, a conference serial number, or the like.

However, in a narrow-down search by the above search function, it is difficult to grasp a serial flow of a certain topic from documents in which new topics or points at issue occur one after another.

### BRIEF DESCRIPTION OF THE DRAWINGS

FIG. 1 is a block diagram illustrating a document search apparatus according to a first embodiment.

FIG. 2 is a flowchart illustrating an operation of the document search apparatus according to the first embodiment.

FIG. 3 is a view illustrating a first example of an extraction process of topics according to the first embodiment.

FIG. 4 is a view illustrating a second example of the extraction process of topics according to the first embodiment.

FIG. 5 is a view illustrating a third example of the extraction process of topics according to the first embodiment.

FIG. 6 is a view illustrating an example of a trained model according to the first embodiment.

FIG. 7 is a view illustrating a display example of a search result of a query according to the first embodiment.

FIG. 8 is a view illustrating another example of a search result of a query according to the first embodiment.

FIG. 9 is a block diagram illustrating a learning apparatus according to a second embodiment.

FIG. 10 is a view for describing a training method of a mixed model according to the second embodiment.

FIG. 11 is a block diagram illustrating an example of a hardware configuration of the document searching apparatus and learning apparatus.

FIG. 12 is a view illustrating a display example of a search result of a query according to conventional art.

### DETAILED DESCRIPTION

In general, according to one embodiment, a document search apparatus includes a processor. The processor searches, from a plurality of documents, one or more related documents which relate to a query. The processor extracts one or more topics of the one or more related documents. The processor determines a display order of the one or more related documents by using a trained model which generates the display order and summaries of documents. The processor generates summaries of the one or more related documents for each of the one or more topics, by using a determination result of the display order and the trained model.

Hereinafter, a document search apparatus, method, program and a learning apparatus according to embodiments will be described with reference to the accompanying drawings. Note that in the embodiments below, parts denoted by identical reference signs are assumed to perform similar operations, and an overlapping description is omitted unless where necessary.

### First Embodiment

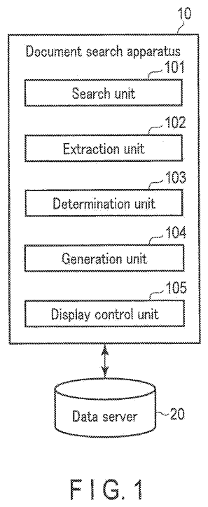

A document search apparatus according to a first embodiment will be described with reference to a functional block diagram of FIG. 1.

A document search apparatus 10 according to the first embodiment includes a search unit 101, an extraction unit 102, a determination unit 103, a generation unit 104, and a display control unit 105.

The search unit 101 searches one or more related documents which relate to a query, from among a plurality of documents which are search targets stored in a data server 20. The query is, for example, a keyword which is input by a user. The documents, which are search targets stored in the data server 20, are, for example, minutes, written questions in the Diet, and local assembly conference minutes, and it is assumed that the documents include sets of question sentences and answer sentences. Aside from this, the documents may be documents having correspondence structures in which a first document, such as a text with a translation, and a second document relating to the first document, are paired.

The extraction unit 102 receives one or more related documents, which are a search result, from the search unit 101, and extracts information relating to topics of the related document.

The determination unit 103 receives the information relating to the topics from the extraction unit 102, and determines a display order of the related documents by using a trained model which generates ordering and summaries of the documents.

The generation unit 104 generates summaries of related documents for each topic or each topic group (to be described later), by using the determination result of the display order by the determination unit 103 and the trained model which generates ordering and summaries of the documents.

The display control unit 105 receives the summaries of the related documents in regard to each topic from the generation unit 104, groups the summaries of the documents in regard to each topic or each topic group, and executes control to display the grouped summaries on an external display or the like.

Note that the trained model may be stored in a storage (not illustrated) in the document search apparatus 10, or may be stored in an external server. When the trained model is stored in the external server, the document search apparatus 10 may use the trained model by accessing the external server.

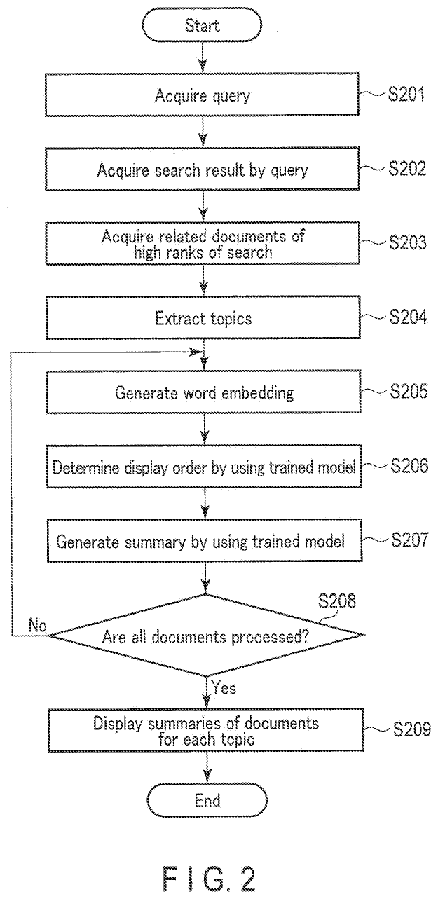

Next, an operation of the document search apparatus 10 according to the first embodiment will be described with reference to a flowchart of FIG. 2.

In step S201, the search unit 101 acquires a query.

In step S202, the search unit 101 searches the data server 20 by using the query, and acquires related documents relating to the query as a search result. In an acquisition method of the related documents, for example, an existing method such as BM25 can be used, in which a precision score indicative of a degree of precision of documents is calculated from an inclusive relation between the length of documents that are search targets and an occurrence statistical amount of words included in the documents, and the query.

Concretely, the precision score is calculated by the following equation (1).

$$score ( D , Q ) = {\sum }_{i = 1}^{n} IDF ( {q}_{i} ) \cdot \frac{f ( {q}_{i} , D ) \cdot ( {k}_{1} + 1 )}{f ( {q}_{i} , D ) + {k}_{1} \cdot ( 1 - b + b \cdot \frac{\vert D \vert}{avgdl} )} \qquad ( 1 )$$

In equation (1), D is indicative of documents with respect to which a relevance score is to be calculated, and Q is indicative of a query including words q₁, . . . , qₙ. In addition, in the right side, IDF (Inverse Document Frequency) is indicative of an inverse of document frequency, and a value obtained by multiplying a reciprocal number of the number of documents, in which a certain word occurs, by the number of words, and applying log to the result of multiplication. Symbol “avgdl” is indicative of an average number of words of a document set, and |D| is indicative of the number of words of a document D. Symbols k₁ and b are indicative of arbitrary parameters, and k₁=[1.2, 2.0], and b=0.75 are conventionally used.

In step S203, the search unit 101 acquires, from among the related documents obtained as the search result, a predetermined number of related documents from the document of the highest rank of the relevance score. For example, the search unit 101 calculates the relevance scores of documents to the query, and acquires, as the predetermined number, the related documents of processing targets of 100 upper ranks in the order from the highest relevance score. Note that if the search result is less than the predetermined number, the process of subsequent steps may be executed for all the related documents as such.

In step S204, the extraction unit 102 extracts topics for each of the related documents acquired in step S203. The extraction unit 102 extracts a topic, for example, by using, as a key, a document attribute corresponding to a tag or label added to the document.

In step S205, the determination unit 103 generates a distributed representation (hereinafter, referred also to as a word embedding) with respect to the related document from which the topics were extracted. For example, the words in the document are represented by vectors by a process such as word2vec, and thereby the document is expressed by vectors.

In step S206, the determination unit 103 determines a display order by ordering the related document by using the trained model.

In step S207, using the trained model, the generation unit 104 generates a summary of the related document, the display order of which was determined in the upper rank, based on the display order decided in step S206.

In step S208, it is determined whether or not all documents extracted in step S203 were processed. If all documents are processed, the process goes to step S209. If all documents are not processed, i.e. if there is a document which is not processed, the process returns to step S205, and the same process is repeated for the related document which is the next processing target.

In step S209, in this example, the display control unit 105 groups the related documents for each topic, and displays summaries of the related documents. Specifically, for example, the display control unit 105 displays the summaries of the related documents grouped for each topic, in the order from the topic with respect to which the number of related documents grouped for the same topic is greatest. Alternatively, the display control unit 105 may display the summaries of the related documents grouped for each topic, in the order from the topic with respect to which the number of related documents, the display order of which was decided in the upper ranks, is greatest. Besides, the display control unit 105 may display the summaries of the related documents for each of topic groups in which topics are gathered, as will be described later. By the above, the operation of the document search apparatus 10 for one query is completed.

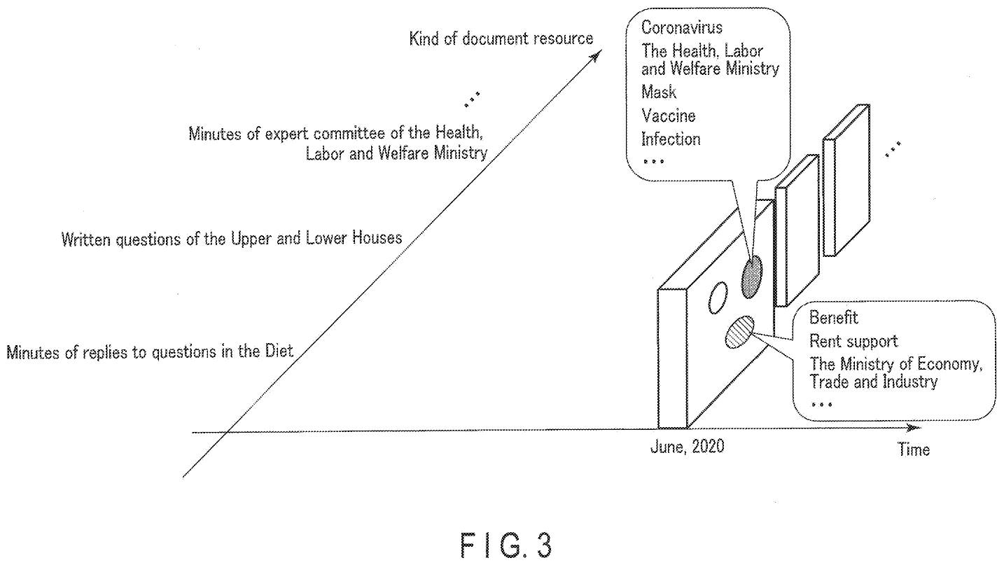

Next, referring to FIG. 3, a description will be given of a first example of the extraction process of topics in step S204.

FIG. 3 illustrates an example of the extraction and grouping of topics in the related documents during a predetermined time period. The vertical axis indicates the kind of document resource, and the horizontal axis indicates time.

In an extraction method of topics, for example, information relating to topics correlated with the documents is extracted by, for example, a topic model based on latent Dirichlet allocation (LDA). In addition, from the inclusive relation between the words occurring in documents, the documents are brought together in a bottom-up manner by a clustering method represented by the K-means method, and thereby the related topics are grouped.

In the example of FIG. 3, topics are extracted from document resources of such kinds as “Minutes of replies to questions in the Diet”, “Written questions of the Upper and Lower Houses”, and “Minutes of expert committee of the Health, Labor and Welfare Ministry”. In June, 2020, topics, such as “Coronavirus, the Health, Labor and Welfare Ministry, Mask, Vaccine, Infection”, are grouped as topics relating to infection, and are brought together, from among the documents included in the “Minutes of replies to questions in the Diet”. In addition, topics, such as “Benefit, Rent support, the Ministry of Economy, Trade and Industry”, are grouped as topics relating to policies, and are brought together. Note that the topics, which are brought together, are also referred to as “topic group”.

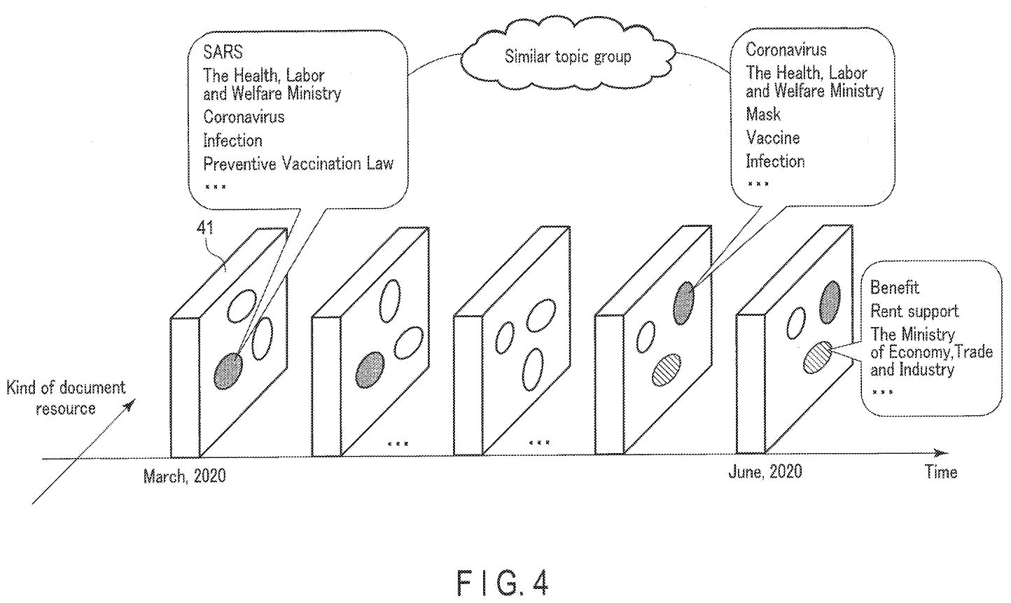

Next, referring to FIG. 4, a description will be given of a second example of the extraction process of topics in step S204.

In FIG. 4, like FIG. 3, the vertical axis indicates the kind of document resource, and the horizontal axis indicates time. In the example of FIG. 4, one document resource is set as a target, and similar topics (or a similar topic group), in which a difference in transition of topics due to the time sequences is absorbed, are illustrated.

In the document resource that is the target of topic extraction, for example, in a predetermined unit period such as one month, the documents are divided (sliced) in the time-axis direction, and topics are extracted from documents 41 divided by the unit period. The contents of the generated topics are independent between the respective division units.

Distributed representation vectors of words included in topics are calculated between the documents of the respective division units, and the similarity between the topics is calculated, for example, by cosine similarity, as a distance between the word embedding vectors. Thereby, similar topics, which are correlated over the time sequence, can be extracted.

Specifically, for example, in the topic group including the topic “Coronavirus” in around June, 2020 and in the topic group including the topic “SARS” in around March 2003 in the past, the included words co-occur with a high probability. Thus, in this case, the similarity is determined to be a threshold or more, and these topic groups are extracted as similar topics (or similar topic groups).

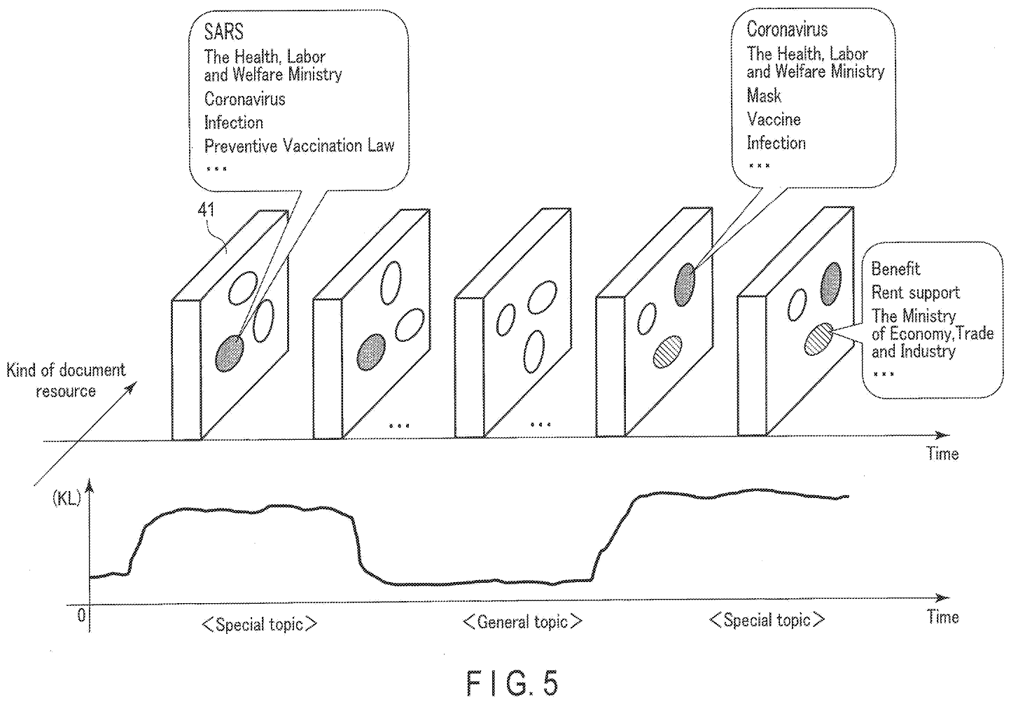

Next, referring to FIG. 5, a description will be given of a third example of the extraction process of topics in step S204.

FIG. 5 illustrates a case of calculating a specificity of topics, and an upper part of FIG. 5 is a view similar to FIG. 3 and FIG. 4. A lower part of FIG. 5 is a graph of a KL value which is calculated by KL divergence of topics along the time sequence. The specificity in the embodiment means a case in which, compared to an average frequency distribution of occurring words in the entirety of documents, when the documents are limited to related documents including a specific topic in a specific time width, there is a deviation from the frequency distribution of occurring words in the documents. The KL value of the KL divergence can be calculated by, for example, equation (2).

$$\begin{matrix}KL [ q ( x ) \vert \vert p ( x ) ] = q ( x ) ln \frac{p ( x )}{q ( x )} \\ = q ( x ) ln p ( x ) - q ( x ) ln q ( x )\end{matrix} \qquad ( 2 )$$

In the example of FIG. 5, the related documents relating to the topic group including the topic “SARS” and the topic group including the topic “Coronavirus” have relatively high KL values. Thus, in these topic groups or the periods thereof, the specificity is high, or, in other words, it is indicated that the topics have novel contents. On the other hand, in topic groups or periods in which the KL value is relatively low, the specificity is low, or, in other words, it is indicated that the topics have general contents.

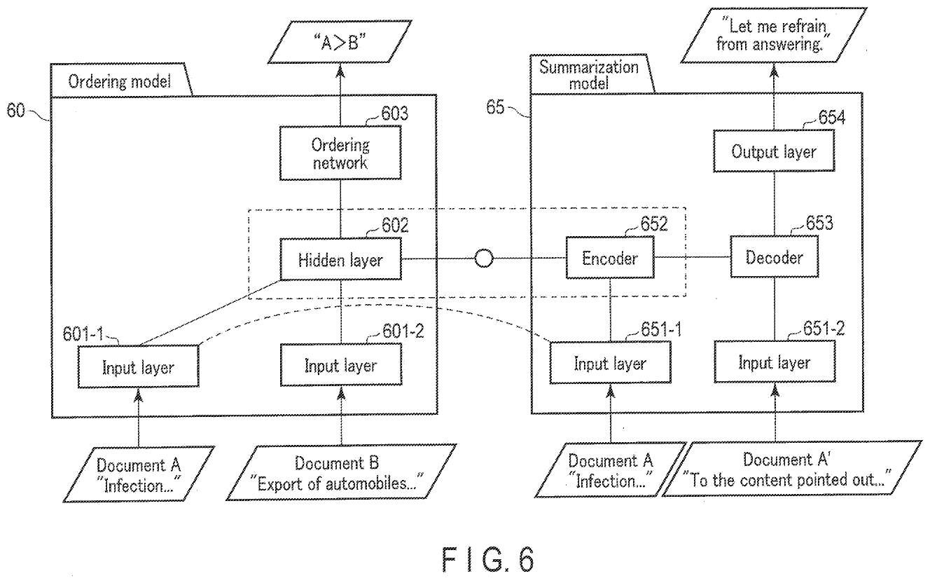

Next, referring to FIG. 6, a description will be given of a trained model for ordering between related documents and for summary generation.

A trained model illustrated in FIG. 6 is a model in which a mixed model including an ordering model 60 for ordering related documents, and a summary generation model 65 for generating a summary, is trained. In the mixed model, a structure of a multilayered neural network is assumed. However, aside from this, any model can be used if a model can execute ordering and summary generation.

The ordering model 60 includes input layers 601, a hidden layer 602, and an ordering network 603. The summary generation model 65 includes input layers 651, an encoder 652, a decoder 653, and an output layer 654.

Furthermore, the trained model shares a part of layers between the ordering model 60 and the summary generation model 65. Specifically, at least a part of layers is shared between the hidden layer 602 of the ordering model 60 and the encoder 652 of the summary generation model 65.

Note that, in the embodiment, as the summary generation model 65, an encoder-decoder model, which is a so-called “Transformer”, is assumed. However, other models using Transformer, such as bidirectional encoder representations from transformers (BERT) and Text-to-Text transfer transformer (T5), may be adopted. Alternatively, aside from Transformer, such models as recurrent neural network (RNN) and long short-term memory (LSTM) may be used, and any model may be used if a model is generally used in machine learning of natural language processing (NLP).

In addition, for the purpose of convenience of description, input layers 601-1 and 601-2 and input layers 651-1 and 651-2 are illustrated so as to indicate a case in which one document is processed in one input layer. Aside from this, a plurality of documents may be sequentially processed in one input layer.

An operation of the ordering model 60 will be described.

Related documents, which are comparison targets for ordering, are input to the two input layers 601, respectively. Here, the input documents are assumed to be minutes in which questions and answers are recorded, and documents corresponding to question sentences are input. Note that a document, which is a set of a question sentence and an answer sentence, may be input. For example, it is assumed that the input document is subjected to processing of Word2Vec, for example, by the determination unit 103, and the input document is represented by word embedding (vector representation).

The hidden layer 602 is a network structure of one or more layers, and the two documents, which are represented by the word embedding, are further abstracted by the hidden layer 602.

The ordering network 603 produces an output as to which of the two abstracted documents is positioned in the upper rank, for example, which of the two abstracted documents is a document of an upper rank in the display order. Here, it is assumed that the ordering model 60 is trained such that when the user confirms the details of an input document, the document whose details are confirmed is set in the upper rank. Thus, the relation between the two documents is output such that the document, whose details are confirmed, is set in the upper rank.

In the example of FIG. 6, document A, “Infection . . . ”, is input to the input layer 601-1, and document B, “Export of automobiles . . . ”, which is the target of the ordering, is input to the input layer 601-2. Here, the case is assumed in which such a result is obtained that the document A is higher in the rank of the order than the document B, and “A>B” is output as the output of the ordering model 60.

Next, an operation of the summary generation model 65 will be described.

Documents for summarization are input to the two input layers 651, respectively. The document, which was determined to have the higher rank in the ordering model 60, is input to the input layer 651-1. In the example of FIG. 6, since the case is assumed in which the document A is determined to have the higher rank than the document B, the document A is input to the input layer 651-1. A document, which is an answer sentence paired with the document A, and which is a summarization target, is input to the input layer 651-2 as a document A′. Note that the summarization target is not limited to the answer sentence, and may be the document A that is the question sentence. In this case, the document A is input to the input layer 651-2. Needless to say, the set of the document A and document A′ may be input to the input layer 651-2, and summaries of both of the document A and the document A′ may be output.

The document A is input to the encoder 652 from the input layer 651-1. The encoder 652 encodes the document A, and generates intermediate data.

The document B is input to the decoder 653 from the input layer 651, and the intermediate data is input to the decoder 653 from the encoder 652, and the decoder 653 decodes the document A′.

The decoded document A′ is input to the output layer 654, and a summary of the document A′ is output. Specifically, the output layer 654 outputs an answer sentence in which the content of the question sentence is taken into account.

In the example of FIG. 6, the document, “Infection . . . ”, which is the same as the document input to the input layer 601-1 of the ordering model 60, is input to the input layer 651-1. The entire answer sentence, “To the content pointed out . . . ”, of the document A is input to the input layer 651-2 as the document A′ which is input to the decoder 653. For example, when it is assumed that the gist of the document A′ is the refraining from an answer, a summary of the document A′, “Let me refrain from answering.”, is output.

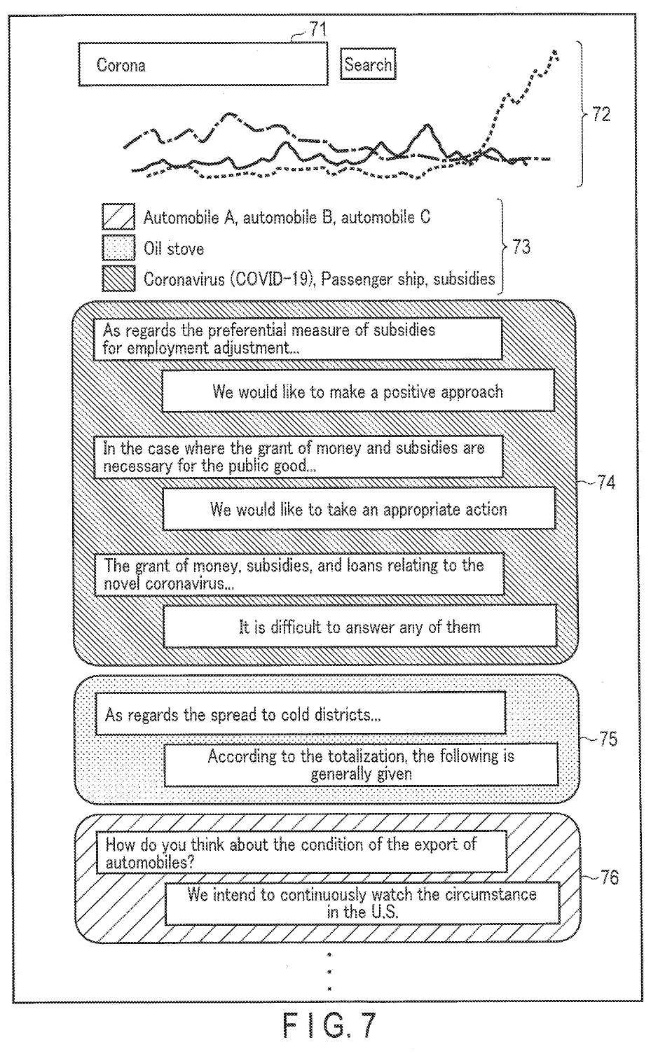

Next, referring to FIG. 7, a description will be given of a display example of the search result of the query in step S209.

FIG. 7 illustrates a display example of summaries for topic groups, which are displayed on a display or the like. Note that, in this example, although summaries for respective topic groups are illustrated, summaries for respective topics may be collected and displayed.

In the same manner as described above, the display control unit 105 displays summaries in the order from the topic group with the greatest number of related documents, based on the ordering that is output from the trained model. Note that the KL value may be included as the attribute information of topics. In this case, summaries may be displayed in the order from the topic group including the topic with the highest KL value. Alternatively, the KL value may be used as a weight for the count number, and calculation and display may be performed such that a topic with a higher KL value, i.e. a topic with a higher novelty, has a higher rank in the display order.

In addition, the display control unit 105 may decide which of a first topic group and a second topic group has a higher rank in the display order, by a majority decision of results of the ordering between the related documents included in the first topic group and the related documents included in the second topic group. Specifically, for example, the related documents included in the first topic group and the related documents included in the second topic group are input to the ordering model, and, when the number of decisions of higher ranks of related documents is greater in the first topic group, the rank in the display order of the first topic group may be placed above the rank in the display order of the second topic group. Concretely, in the example of FIG. 7, since the number of related documents included in the topic group including “Coronavirus” is greater than the number of related documents included in the topic group including “Oil stove”, the topic group including “Coronavirus” is displayed in the upper rank.

If the user inputs a query to a search window 71, the document search apparatus 10 displays a graph 72 illustrating an occurrence frequency of each topic along a time sequence, topic groups 73, and summary displays 74 to 76 in which the summaries of documents, which are search results of the query, are collected for respective topics, in the order determined by the ordering model. In the topic groups 73, the topics included in each topic group are also indicated.

In the example of FIG. 7, the case is assumed in which, when “Corona” was searched, the topic group including the topic of the coronavirus (COVID-19) was determined to have the highest rank, and sets of questions and answers relating to the novel coronavirus are displayed as one topic group in one box. Here, question sentences and the summaries of answer sentences, which are obtained by the trained model, are displayed as sets.

Note that, in this example, the backgrounds of the respective topic groups are distinguished and displayed. Aside from this, other display modes, which enable distinction at first glance between topics or between topic groups, may be implemented by, for example, colors, kinds of characters, character sizes, highlight, bold face, or ornament of flickering, or the like.

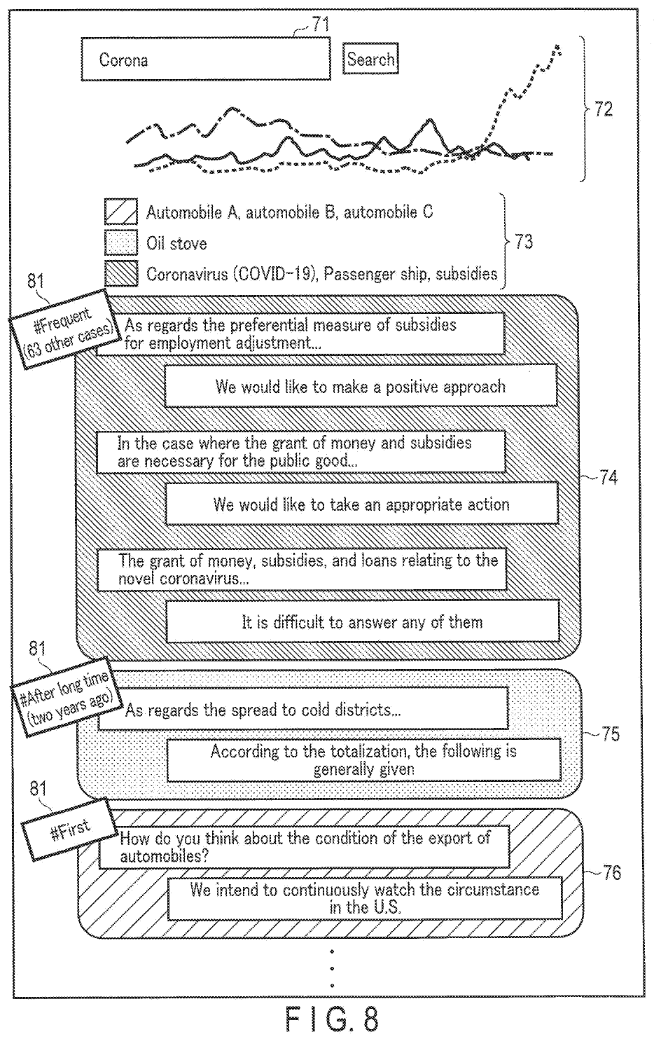

Next, another example of the search result display of the query will be described with reference to FIG. 8.

The display control unit 105 displays topic groups by adding labels to the topic groups in accordance with occurrence frequencies of topics of search results.

An example of the label may be selected from 4H expressions (“Hajimete (First)”, “Hisashibri (After long time)”, “Hinpan (Frequent)”, and “Hikitsugi (Continued)”).

For example, the label “First” is added to a topic group which first occurs in the time sequence. Similarly, the label “After long time” is added if an identical or similar topic was present in the past, and a predetermined period has passed since the occurrence of the identical or similar topic. If a similar topic was present in the past and the similar topic has occurred several times within a predetermined period from the occurrence of the similar topic in the past, the label “Frequent” is added.

In the example of FIG. 8, labels 81, “#Frequent”, “#After long time” and “#First”, are displayed for the topic groups in a so-called “hashtag” form. Note that the search hit number in the topic may be also displayed like “#Frequent (63 other cases)”, and the time of previous occurrence of the document relating to the topic may be also displayed like “After long time (two years ago)”.

According to the above-described first embodiment, related documents relating to a query are acquired, topics of the related documents are extracted, and ordering between the related documents and summary generation of the related documents are executed by using a trained model which is trained to execute ordering and summary generation. Furthermore, summaries of documents are displayed for each topic (or for each topic group) to which topics correlated with the related documents belong. Thereby, since not simple display in units of a document, but display in units of a topic or in units of a topic group, to which documents belong, is performed, the relation between topics can be understood at first glance. Besides, since at least an answer sentence in each topic group is summarized and displayed, a large amount of information can be displayed even in a limited display area of a display or the like.

Moreover, by calculating the occurrence frequency of topics in the time-axis direction, labels can be added to the topics or topic groups. Since information from a viewpoint different from the summarization can be presented, the user can obtain a greater amount of information, even with snippet display in the limited display area. Thus, a search result that is easy to grasp can be provided.

### Second Embodiment

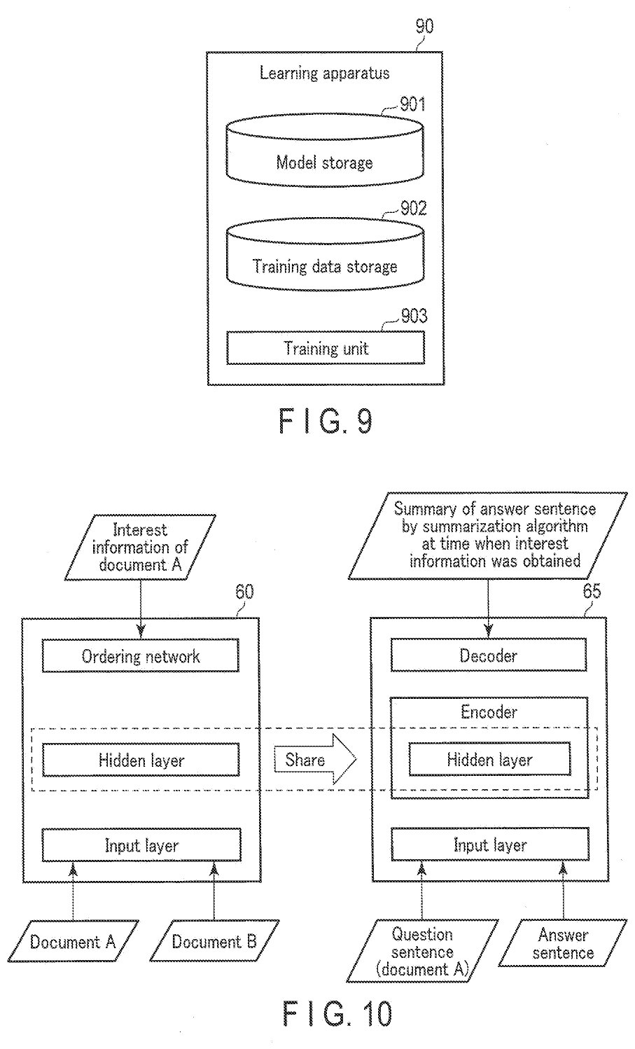

In a second embodiment, a learning apparatus for training a trained model will be described with reference to FIG. 9.

A learning apparatus 90 according to the second embodiment includes a model storage 901, a training data storage 902, and a training unit 903.

The model storage 901 stores a mixed model prior to training, which includes a model for executing ordering between documents, and a model for executing summary generation.

The training data storage 902 stores, as training data, a plurality of sets of input data and correct answer data for training a mixed model. For the model which executes the ordering between documents, a plurality of training data are prepared, in which two documents (question sentences) that are comparison targets are used as input data, and interest information, which is added to one of the two documents, is used as correct answer data. The interest information is information which is obtained by taking a log of actions, such as clicks on documents by the user, and which indicates that the user viewed a document with an interest in the document.

On the other hand, for the model which executes summary generation, a plurality of training data are prepared, in which a question sentence and an answer sentence are used as input data, and a summary of the answer sentence is used as correct answer data. The summary may be generated from the input answer sentence, by using an existing algorithm. Examples of the existing summarization algorithm include TFIDF-max, LexRank, and EmbRank.

The training unit 903 generates a trained model by training the mixed model stored in the model storage 901, with use of the training data stored in the training data storage 902. As regards the training of the model using the training data, for example, a general supervised machine learning method may be used.

Note that the learning apparatus 90 may not include the training data storage 902, and may acquire training data from an external server or the like, which stores training data.

Next, a training method of a mixed model will be described with reference to FIG. 10.

A document A, which is a document with interest information, and a document B, which a document without interest information, are input as input data to the ordering model 60, and a result that the document A with the interest information has a higher rank than the document B is input as correct answer data, thereby executing training of the ordering model 60. Through the training, the ordering model 60 can be trained such that the document, the details of which were confirmed by the user, has a higher rank in the order than the document, the details of which are not confirmed.

On the other hand, in the training of the summary generation model 65, a document (a question sentence) with interest information, and an answer sentence, which is paired with the question sentence, are input as input data to the summary generation model 65, and a summary of the answer sentence, which was generated by the summarization algorithm at the time when the interest information was acquired, is input as correct answer data, thereby executing the training of the summary generation model 65.

In addition, the summary generation model 65 shares the hidden layer of the ordering model 60 as a part of the encoder. Thereby, information of good/bad by the user's view point in regard to the summary that is the correct answer data and the summarization algorithm can be propagated by the layer in which the weight relating to the interest information was trained in the ordering model 60.

Specifically, as regards a document with which interest information can be obtained, for example, a document which was clicked by the user in order to confirm the details, it is supposed that the user recognized the value of the document. Under this supposition, it can be supposed that there is a value in regard to not only the order of the document, but also the summary presented as a snippet at the same time. Thus, a teaching can be given that the summarization algorithm applied to the answer sentence (or the corresponding question sentence) that is the original document of the summary is appropriate. Therefore, as so-called multi-task training, the generation of an appropriate summary sentence can be achieved.

When click logs of a plurality of users are used as interest information, the ordering of documents as collective intelligence can be executed. In addition, when a click log of one user is used as interest information, the ordering of documents in accordance with the interest of an individual user can be executed.

Note that, as a first modification of the correct answer data of the summary generation model 65, a summary of an answer sentence, which is generated by using an algorithm selected at random from a plurality of summarization algorithms, may be input. In this case, by the layer shared with the ordering model 60, training can be performed with consideration given to whether or not the summarization algorithm that is input as correct answer data is appropriate.

In addition, as a second modification of the correct answer data of the summary generation model 65, training may be performed by using, as correct answer data, the summary of the question sentence, in addition to the summary of the answer sentence. Thereby, at a time of inference, the summary of each of the question sentence and the answer sentence can be output.

Furthermore, training may be executed by delivering topic documents, in which a plurality of documents including question sentences are bundled, as input data to the summary generation model 65, and delivering summaries of the topic documents as correct answer data to the summary generation model 65. Thereby, summaries can be output, not in units of a sentence, or in units of a pair of a question sentence and an answer sentence, but in units of a topic, which is a greater unit.

Note that the learning apparatus 90 may train, as well as the mixed model as in the embodiment, a model so as to execute multi-tasks, and may generate a trained model of multi-tasks. By adding labels to designate tasks such as “ordering” and “summarization” together with the input data, the same process as in the mixed model described in the present embodiment can be executed.

According to the above-described second embodiment, the mixed model including the ordering model and the summary generation model, which share a part of layers, is trained. Thereby, appropriate ordering and summary generation can be executed for the input documents, and appropriate search results and summaries of search results, in which the user's query and interest are taken into account, can be presented.

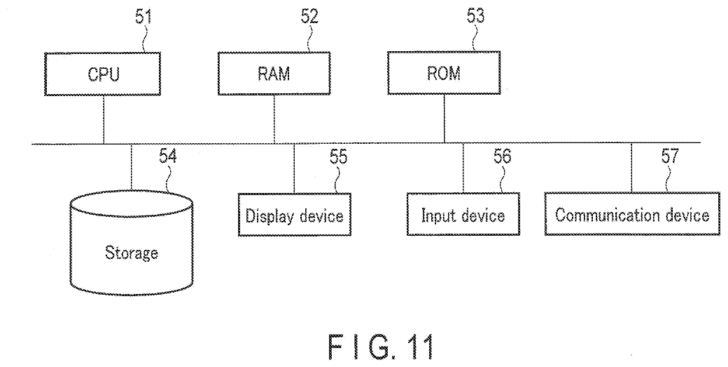

Next, FIG. 11 illustrates an example of a hardware configuration of the document search apparatus 10 and learning apparatus 90 according to the above embodiment.

The document search apparatus 10 and learning apparatus 90 are realized by a central processing unit (CPU) 51, a random access memory (RAM) 52, a read only memory (ROM) 53, a storage 54, a display device 55, an input device 56 and a communication device 57, and these components are connected by a bus.

The CPU 51 is a processor which executes an arithmetic process and a control process, or the like according to programs. The CPU 51 uses a predetermined area of the RAM 52 as a working area, and executes various processes in cooperation with programs stored in the ROM 53 and storage 54, or the like. Note that the above-described processes of the document search apparatus 10 and the above-described processes of the learning apparatus 90 may be executed by the CPU 51.

The RAM 52 is a memory such as a synchronous dynamic random access memory (SDRAM). The RAM 52 functions as the working area of the CPU 51. The ROM 53 is a memory which stores programs and various information in a non-rewritable manner.

The storage 54 is a device which writes and reads data to and from a magnetic recording medium such as a hard disc drive (HDD), a semiconductor storage medium such as a flash memory, a magnetically recordable storage medium such as an HDD, or an optically recordable storage medium. The storage 54 writes and reads data to and from the storage medium in accordance with control from the CPU 51.

The display device 55 is a display device such as a liquid crystal display (LCD). The display device 55 displays various information, based on a display signal from the CPU 51.

The input device 56 is an input device such as a mouse and a keyboard, or the like. The input device 56 accepts, as an instruction signal, information which is input by a user's operation, and outputs the instruction signal to the CPU 51.

The communication device 57 communicates, via a network, with an external device in accordance with control from the CPU 51.

### Comparative Example

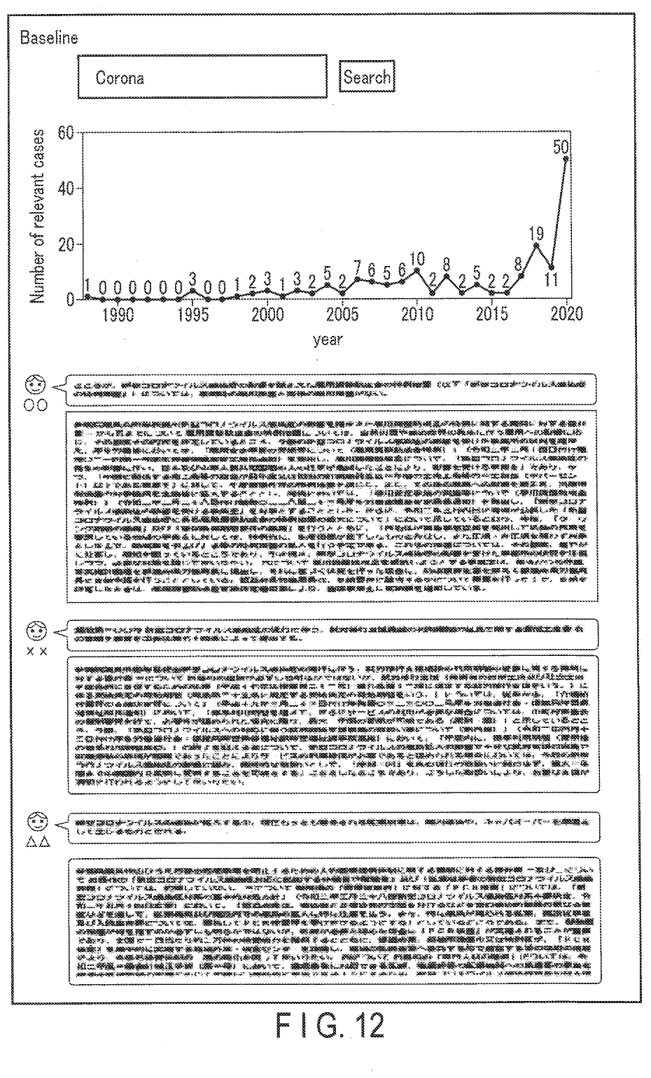

FIG. 12 illustrates, as conventional art, a display example of a search result relating to a query from a user.

As illustrated in FIG. 12, a search result by full-text search is displayed, and all of question sentences and answer sentences, which correspond to the query input by the user, are displayed. Thus, in this comparative example, since an area for displaying all sentences is needed, the number of question sentences and answer sentences, which are displayed on the display area, is small. Furthermore, since all sentences are described, it is difficult to grasp the main points of the sentences.

On the other hand, according to the document search apparatus of the embodiment, documents are not sequentially displayed on a document-by-document basis, but documents are summarized and displayed in units of a topic (or in units of a topic group) to which documents belong, and the summaries are displayed in the order in units of the topic or the topic group. Thus, search results that are easy to grasp can be provided.

The instructions indicated in the processing procedure illustrated in the above embodiment can be executed based on a program that is software. A general-purpose computer system may prestore this program, and may read in the program, and thereby the same advantageous effects as by the control operations of the above-described document search apparatus and learning apparatus can be obtained. The instructions described in the above embodiment are stored, as a computer-executable program, in a magnetic disc (flexible disc, hard disk, or the like), an optical disc (CD-ROM, CD-R, CD-RW, DVD-ROM, DVD±R, DVD±RW, Blu-ray (trademark) Disc, or the like), a semiconductor memory, or other similar storage media. If the storage medium is readable by a computer or an embedded system, the storage medium may be of any storage form. If the computer reads in the program from this storage medium and causes, based on the program, the CPU to execute the instructions described in the program, the same operation as the control of the document search apparatus and learning apparatus of the above-described embodiment can be realized. Needless to say, when the computer obtains or reads in the program, the computer may obtain or read in the program via a network.

Additionally, based on the instructions of the program installed in the computer or embedded system from the storage medium, the OS (operating system) running on the computer, or database management software, or MW (middleware) of a network, or the like, may execute a part of each process for implementing the embodiment.

Additionally, the storage medium in the embodiment is not limited to a medium which is independent from the computer or embedded system, and may include a storage medium which downloads, and stores or temporarily stores, a program which is transmitted through a LAN, the Internet, or the like.

Additionally, the number of storage media is not limited to one. Also when the process in the embodiment is executed from a plurality of storage media, such media are included in the storage medium in the embodiment, and the media may have any configuration.

Note that the computer or embedded system in the embodiment executes the processes in the embodiment, based on the program stored in the storage medium, and may have any configuration, such as an apparatus composed of any one of a personal computer, a microcomputer and the like, or a system in which a plurality of apparatuses are connected via a network.

Additionally, the computer in the embodiment is not limited to a personal computer, and may include an arithmetic processing apparatus included in an information processing apparatus, a microcomputer, and the like, and is a generic term for devices and apparatuses which can implement the functions in the embodiment by programs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A document search apparatus comprising a processor configured to:
search, from a plurality of documents, one or more related documents which relate to a query;
extract one or more topics of the one or more related documents;
determine a display order of the one or more related documents by using a trained model which generates the display order and summaries of documents; and
generate summaries of the one or more related documents for each of the one or more topics, by using a determination result of the display order and the trained model.

2. The apparatus according to claim 1, wherein the processor is further configured to group the summaries of the one or more related documents for each of the one or more topics, and to display the grouped summaries.

3. The apparatus according to claim 2, wherein the processor displays the summaries in an order from a topic with respect to which the number of related documents grouped for the same topic is greatest.

4. The apparatus according to claim 2, wherein the processor adds a label to each topic, the label being based on an occurrence frequency of each topic along a time sequence.

5. The apparatus according to claim 1, wherein the related document has a structure that a first document and a second document which relates to the first document are paired.

6. The apparatus according to claim 5, wherein the processor generates a summary of at least the second document.

7. The apparatus according to claim 2, wherein
the related document has a structure that a first document and a second document which relates to the first document are paired, and
the processor displays the first document and a summary of the second document as a set, in a group of the related documents that a plurality of related documents are grouped by being regarded as including an identical topic.

8. The apparatus according to claim 5, wherein the first document is a question sentence, and the second document is an answer sentence to the question sentence.

9. A document search method comprising:
searching, from a plurality of documents, one or more related documents which relate to a query;
extracting one or more topics of the one or more related documents;
determining a display order of the one or more related documents by using a trained model which generates the display order and summaries of documents; and
generating summaries of the one or more related documents for each of the one or more topics, by using a determination result of the display order and the trained model.

10. The method according to claim 9, further comprising:
grouping the summaries of the one or more related documents for each of the one or more topics; and
displaying the grouped summaries.

11. The method according to claim 10, further comprising displaying the summaries in an order from a topic with respect to which the number of related documents grouped for the same topic is greatest.

12. The method according to claim 10, further comprising adding a label to each topic, the label being based on an occurrence frequency of each topic along a time sequence.

13. The method according to claim 9, wherein the related document has a structure that a first document and a second document which relates to the first document are paired.

14. The method according to claim 13, further comprising generating a summary of at least the second document.

15. The method according to claim 10, wherein
the related document has a structure that a first document and a second document which relates to the first document are paired, and
the displaying displays the first document and a summary of the second document as a set, in a group of the related documents that a plurality of related documents are grouped by being regarded as including an identical topic.

16. The method according to claim 13, wherein the first document is a question sentence, and the second document is an answer sentence to the question sentence.

17. A learning apparatus comprising a processor configured to:
generate an ordering model determining a display order such that a first document to which interest information is added, among the documents which are input, has an upper rank in the display order, by training a first model using a plurality of documents which are comparison targets as input data and the interest information as correct answer data, the interest information indicating that a user has an interest in one of the documents; and
generate a summary generation model generating the summary of a second document, by training a second model which shares a part of layers with the first model using the first document and the second document as input data and a summary of the second document as correct answer data, the second document being a document paired with the first document.
